(19) United States
(12) Patent Application Publication
(10) Pub. No.: US 2025/0072506 A1
(43) Pub. Date: Mar. 6, 2025

(54) AEROSOL GENERATING DEVICE INCLUDING HEATER MODULE

(71) Applicant: KT & G CORPORATION, Daejeon (KR)

(72) Inventors: Jong Sub LEE, Gyeonggi-do (KR); Sun Hwan JUNG, Gyeonggi-do (KR); Byung Sung CHO, Gyeonggi-do (KR)

(73) Assignee: KT & G CORPORATION, Daejeon (KR)

(21) Appl. No.: 18/563,650

(22) PCT Filed: Jul. 27, 2023
(86) PCT No.: PCT/KR2023/010954

§ 371 Date: Nov. 22, 2023

(30) Foreign Application Priority Data
Jul. 28, 2022 (KR) 10-2022-0094031
Oct. 5, 2022 (KR) 10-2022-0127390

(51) Int. Cl. A24F 40/465; A24F 40/10; A24F 40/20; A24F 40/30; A24F 40/42; A24F 40/51; A24F 40/53; A24F 40/60; A24F 40/65

(52) U.S. Cl. CPC A24F 40/465; A24F 40/42; A24F 40/51; A24F 40/53; A24F 40/60; A24F 40/10; A24F 40/20; A24F 40/30; A24F 40/65

(57) ABSTRACT

The present disclosure relates to an aerosol generating device including a heater module that is detachable, wherein the aerosol generating device includes a main body including a controller and a battery, a heater module detachably coupled to the main body and including a heater configured to heat an aerosol generating material, and a cartridge detachably coupled to the heater module and configured to store the aerosol generating material to be delivered to the heater, wherein the heater module includes a first terminal configured to electrically connect the cartridge to the heater module when the cartridge is coupled to the heater module, and a second terminal and a third terminal configured to electrically connect the heater module to the controller when the heater module is coupled to the main body.

### TECHNICAL FIELD

One or more embodiments relate to an aerosol generating device including a de-tachable heater module.

### BACKGROUND ART

Recently, as alternative methods to overcome the disadvantages of traditional cigarettes, the demand for methods which generate aerosol by heating an aerosol generating material, rather than by combusting cigarettes has increased. For example, there has been used a method in which a cartridge including a heater and a liquid storage storing an aerosol generating material is configured to be detachable from an aerosol generating device, and as power is transferred from the aerosol generating device to the cartridge, the aerosol generating material stored in the cartridge is heated by the heater.

When all of the aerosol generating material stored in the liquid storage of the cartridge is exhausted, the cartridge is replaced. However, even though the durability of the heater generally lasts longer than an exhaustion cycle of the aerosol generating material, the heater may be needlessly replaced. Accordingly, unnecessary waste may occur, and thus, there may be a need for a technology for reducing such waste by considering a durability or exhaustion time of individual components of an aerosol generating device.

### DISCLOSURE OF INVENTION

### Technical Problem

Various embodiments may provide an aerosol generating device in which a cartridge and a heater module are detachably coupled to each other. Technical problems to be solved by the present disclosure are not limited to the technical problems described above, and other technical problems may be inferred from the following embodiments.

### Solution to Problem

According to one or more embodiments, an aerosol generating device includes a main body including a controller and a battery, a heater module detachably coupled to the main body and including a heater configured to heat an aerosol generating material, and a cartridge detachably coupled to the heater module and storing the aerosol generating material to be delivered to the heater, wherein the heater module includes a first terminal electrically connecting the cartridge to the heater module, and a second terminal and a third terminal electrically connecting the heater module to the controller.

### Advantageous Effects of Invention

The present disclosure provides an aerosol generating device in which a cartridge and a heater module are detachable from each other, thereby enabling replacement of the individual components of the aerosol generating device according to the durability and availability of the components.

In addition, the aerosol generating device according to an embodiment may identify whether the cartridge, the heater module, and the main body are coupled.

In addition, since the aerosol generating device according to an embodiment operates differently in response to the same user input according to whether the cartridge is coupled, a user input interface may be simplified.

### BRIEF DESCRIPTION OF DRAWINGS

FIGS. 1 to 3 are diagrams of examples of an aerosol generating device with a cigarette inserted thereinto.

FIGS. 4 and 5 each illustrate an example of a cigarette.

FIG. 6 is a perspective view of an aerosol generating device according to an embodiment.

FIG. 7 is an exploded perspective view the aerosol generating device shown in FIG. 6.

FIG. 8 is a block diagram illustrating a configuration of an aerosol generating device according to an embodiment.

FIG. 9 illustrates a method of identifying a connection state of a cartridge and a heater module, according to an embodiment.

FIG. 10 is a flowchart of a method of determining whether a cartridge is coupled according to an embodiment.

FIG. 11 is a block diagram of an aerosol generating device 1100 according to another embodiment.

### BEST MODE FOR CARRYING OUT THE INVENTION

According to one or more embodiments, an aerosol generating device includes a main body including a controller and a battery, a heater module detachably coupled to the main body and including a heater configured to heat an aerosol generating material, and a cartridge detachably coupled to the heater module and configured to store the aerosol generating material to be delivered to the heater, wherein the heater module includes a first terminal configured to electrically connect the cartridge to the heater module when the cartridge is coupled to the heater module, and a second terminal and a third terminal configured to electrically connect the heater module to the controller when the heater module is coupled to the main body.

In an embodiment, the heater module may further include a printed circuit board electrically connecting the first terminal and the third terminal.

In an embodiment, the heater module may further include an integrated circuit mounted on the printed circuit board, and the integrated circuit may be electrically connected to the controller through the third terminal.

In an embodiment, the integrated circuit may count a number of puffs based on a signal transmitted from the controller whenever a puff is detected, and store the counted number.

In an embodiment, the integrated circuit may include a non-volatile memory storing the number.

In an embodiment, the heater may receive power from the battery through the second terminal.

In an embodiment, the cartridge may further include a conductor that is electrically connected to the first terminal when the cartridge is coupled to the heater module.

In an embodiment, the conductor may generate a conducting signal when the conductor is electrically connected to the first terminal, and the controller may receive the conducting signal through the third terminal.

In an embodiment, the conducting signal may be a current flow during a predetermined time or more or a current amount equal to or greater than a reference value.

In an embodiment, the aerosol generating device may further include a user input unit configured to receive a user input, and the controller may be further configured to, in response to the user input, output a first control signal when the conducting signal is less than a reference value, and output a second control signal different from the first signal when the conducting signal is greater than or equal to the reference value.

In an embodiment, the first control signal may block power supplied to the heater.

In an embodiment, the first terminal, the second terminal, and the third terminal may each be configured in a pair.

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and changes such as “comprises” or “comprising” will be understood to imply the inclusion of stated elements but not the exclusion of any other elements. In addition, the terms “-er”. “-or”, and “module” described in the specification mean units for processing at least one function and operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

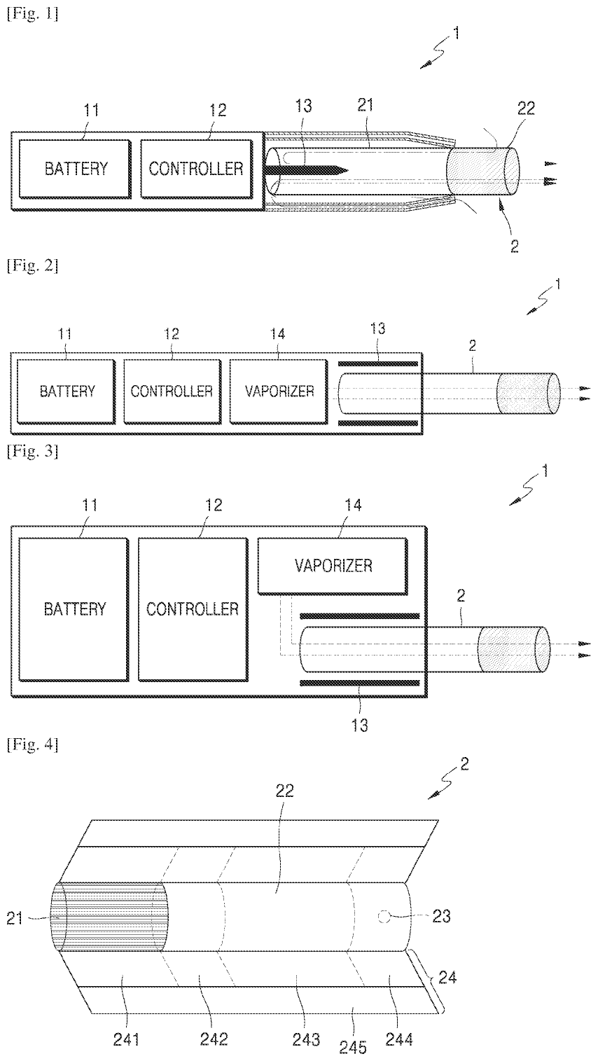

First, referring to FIGS. 1 to 6, an aerosol generating device according to an embodiment will be described.

FIGS. 1 through 3 are diagrams showing examples in which a cigarette is inserted into an aerosol generating device.

Referring to FIG. 1, an aerosol generating device 1 includes a battery 11, a controller 12, and a heater 13. Referring to FIGS. 2 and 3, the aerosol generating device 1 further includes a vaporizer 14. A cigarette 2 may be inserted into an inner space of the aerosol generating device 1.

The elements related to the embodiment are illustrated in the aerosol generating device 1 of FIGS. 1 to 3. Therefore, one of ordinary skill in the art would appreciate that other universal elements than the elements shown in FIGS. 1 to 3 may be further included in the aerosol generating device 1.

Also, although it is shown that the aerosol generating device 1 includes the heater 13 in FIGS. 2 and 3, the heater 13 may be omitted if necessary.

In FIG. 1, the battery 11, the controller 12, and the heater 13 are arranged in a row. Also, FIG. 2 shows that the battery 11, the controller 12, the vaporizer 14, and the heater 13 are arranged in a row. Also, FIG. 3 shows that the vaporizer 14 and the heater 13 are arranged in parallel with each other. However, an internal structure of the aerosol generating device 1 is not limited to the examples shown in FIGS. 1 to 3. That is, according to a design of the aerosol generating device 1, arrangement of the battery 11, the controller 12, the heater 13, and the vaporizer 14 may be changed.

When the cigarette 2 is inserted into the aerosol generating device 1, the aerosol generating device 1 operates the heater 13 and/or the vaporizer 14 to generate aerosol from the cigarette 2 and/or the vaporizer 14. The aerosol generated by the heater 13 and/or the vaporizer 14 may be transferred to a user via the cigarette 2.

If necessary, even when the cigarette 2 is not inserted in the aerosol generating device 1, the aerosol generating device 1 may heat the heater 13.

The battery 11 supplies the electric power used to operate the aerosol generating device 1. For example, the battery 11 may supply power for heating the heater 13 or the vaporizer 14 and supply power for operating the controller 12. In addition, the battery 11 may supply power for operating a display, a sensor, a motor, and the like installed in the aerosol generating device 1.

The controller 12 controls the overall operation of the aerosol generating device 1. In detail, the controller 12 may control operations of other elements included in the aerosol generating device 1, as well as the battery 11, the heater 13, and the vaporizer 14. Also, the controller 12 may check the status of each component in the aerosol generating device 1 to determine whether the aerosol generating device 1 is in an operable state.

The controller 12 includes at least one processor. A processor may be implemented as an array of a plurality of logic gates or may be implemented as a combination of a general-purpose microprocessor and a memory in which a program executable in the microprocessor is stored. It will be understood by one of ordinary skill in the art that the processor can be implemented in other forms of hardware.

The heater 13 may be heated by the electric power supplied from the battery 11. For example, when the cigarette is inserted in the aerosol generating device 1, the heater 13 may be located outside the cigarette. Therefore, the heated heater 13 may raise the tem-perature of an aerosol generating material in the cigarette.

The heater 13 may be an electro-resistive heater. For example, the heater 13 includes an electrically conductive track, and the heater 13 may be heated as a current flows through the electrically conductive track. However, the heater 13 is not limited to the above example, and any type of heater may be used provided that the heater is heated to a desired temperature. Here, the desired temperature may be set in advance on the aerosol generating device 1, or may be set by a user.

In addition, in another example, the heater 13 may include an induction heating type heater. In detail, the heater 13 may include an electrically conductive coil for heating the cigarette in an induction heating method, and the cigarette may include a susceptor that may be heated by the induction heating type heater.

For example, the heater 13 may include a tubular type heating element, a plate type heating element, a needle type heating element, or a rod type heating element, and may heat the inside or outside of the cigarette 2 according to the shape of the heating element.

Also, there may be a plurality of heaters 13 in the aerosol generating device 1. Here, the plurality of heaters 13 may be arranged to be inserted into the cigarette 2 or on the outside of the cigarette 2. Also, some of the plurality of heaters 13 may be arranged to be inserted into the cigarette 2 and the other may be arranged on the outside of the cigarette 2. In addition, the shape of the heater 13 is not limited to the example shown in FIGS. 1 to 3, but may be manufactured in various shapes.

The vaporizer 14 may generate aerosol by heating a liquid composition and the generated aerosol may be delivered to the user after passing through the cigarette 2. In other words, the aerosol generated by the vaporizer 14 may move along an air flow passage of the aerosol generating device 1, and the air flow passage may be configured for the aerosol generated by the vaporizer 14 to be delivered to the user through the cigarette.

For example, the vaporizer 14 may include a liquid storage unit, a liquid delivering unit, and a heating element, but is not limited thereto. For example, the liquid storage unit, the liquid delivering unit, and the heating element may be included in the aerosol generating device 1 as independent modules.

The liquid storage may store a liquid composition. For example, the liquid composition may be a liquid including a tobacco-containing material having a volatile tobacco flavor component, or a liquid including a nontobacco material. The liquid storage unit may be attached to/detached from the vaporizer 14 or may be integrally manufactured with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but is not limited thereto.

In addition, the aerosol generating device 1 may further include universal elements, in addition to the battery 11, the controller 12, the heater 13, and the vaporizer 14. For example, the aerosol generating device 1 may include a display capable of outputting visual information and/or a motor for outputting tactile information. Also, the aerosol generating device 1 may include at least one sensor (a puff sensor, a temperature sensor, an aerosol generating article insertion sensor, etc.). Also, the aerosol generating device 1 may be manufactured to have a structure, in which external air may be introduced or internal air may be discharged even in a state where the cigarette 2 is inserted.

Although not shown in FIGS. 1 to 3, the aerosol generating device 1 may configure a system with an additional cradle. For example, the cradle may be used to charge the battery 11 of the aerosol generating device 1. Alternatively, the heater 13 may be heated in a state in which the cradle and the aerosol generating device 1 are coupled to each other.

The cigarette 2 may be similar as a general combustive cigarette. For example, the cigarette 2 may be divided into a first portion including an aerosol generating material and a second portion including a filter, etc. Alternatively, the second portion of the cigarette 2 may also include an aerosol generating material. For example, an aerosol generating material made in the form of granules or capsules may be inserted into the second portion.

The entire first portion may be inserted into the aerosol generating device 1 and the second portion may be exposed to the outside. Alternatively, only a portion of the first portion may be inserted into the aerosol generating device 1 or the entire first portion and a portion of the second portion may be inserted into the aerosol generating device 1. The user may puff aerosol while holding the second portion by the mouth of the user. In this case, the aerosol is generated by the external air passing through the first portion, and the generated aerosol passes through the second portion and is delivered to the user's mouth.

For example, the outside air may be introduced through at least one air passage formed in the aerosol generating device 1. For example, the opening and closing of the air passage formed in the aerosol generating device 1 and/or the size of the air passage may be adjusted by a user. Accordingly, the amount and the quality of smoking may be adjusted by the user. As another example, the external air may flow into the cigarette 2 through at least one hole formed in a surface of the cigarette 2.

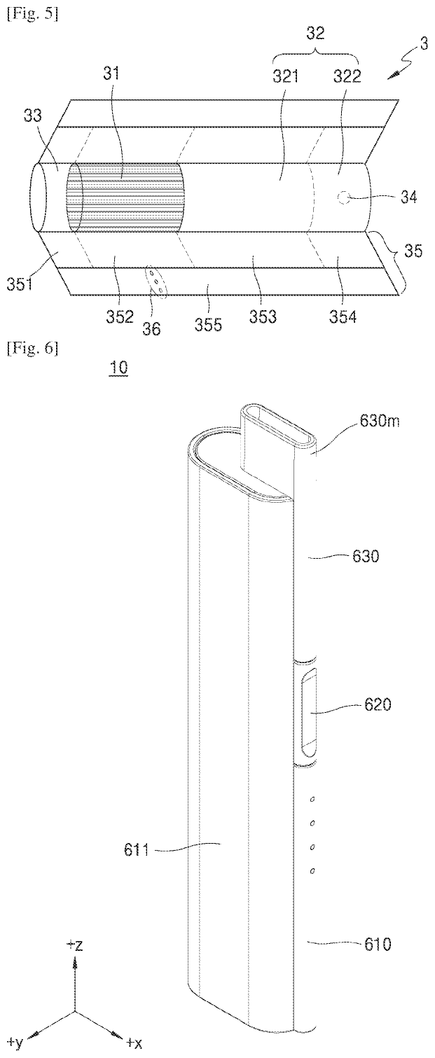

Hereinafter, an example of the cigarette 2 will be described with reference to FIGS. 4 and 5.

FIGS. 4 and 5 illustrate an example of a cigarette.

Referring to FIG. 4, the cigarette 2 includes a tobacco rod 21 and a filter rod 22. The first portion described above with reference to FIGS. 1 through 3 may include the tobacco rod 21, and the second portion may include the filter rod 22.

FIG. 4 illustrates that the filter rod 22 includes a single segment, but is not limited thereto. In other words, the filter rod 22 may include a plurality of segments. For example, the filter rod 22 may include a segment configured to cool an aerosol and a segment configured to filter a certain component included in the aerosol. Also, according to necessity, the filter rod 22 may further include at least one segment configured to perform other functions.

A diameter of the cigarette 2 may range from 5 mm to 9 mm, and a length of the cigarette 20 may be about 48 mm, but embodiments are not limited thereto. For example, the length of the tobacco rod 21 may be about 12 mm, the length of a first segment of the filter rod 22 may be about 10 mm, the length of a second segment of the filter rod 22 is about 14 mm, the length of a third segment may be about 12 mm, but embodiments are not limited thereto.

The cigarette 20 may be packaged via at least one wrapper 24. The wrapper 24 may have at least one hole through which external air may be introduced or internal air may be discharged. For example, the cigarette 2 may be packaged via one wrapper 24. As another example, the cigarette 2 may be doubly packaged via at least two wrappers 24. For example, the tobacco rod 21 may be packaged via a first wrapper 241, and the filter rod 22 may be packaged via wrappers 242, 243, and 244. Also, the entire cigarette 2 may be re-packaged by a fifth wrapper 245, which is a single wrapper. When the filter rod 22 includes a plurality of segments, each segment may be packaged via separate wrappers 242, 243, and 244.

The first wrapper 241 and the second wrapper 242 may be made of a general filter wrapper. For example, the first wrapper 241 and the second wrapper 242 may be a porous wrapper or a non-porous wrapper. In addition, the first wrapper 241 and the second wrapper 242 may be made of a paper and/or aluminum laminate wrapper having oil resistance.

The third wrapper 243 may be made of a hard wrapper. For example, the basis weight of the third wrapper 243 may be within a range of 88 g/m² to 96 g/m², for example, in the range of 90 g/m² to 94 g/m². In addition, the thickness of the third wrapper 243 may be included in a range of 120 μm to 130 μm, for example, about 125 μm.

The fourth wrapper 244 may be made of a hard wrapper having oil resistance. For example, the basis weight of the fourth wrapper 244 may be within a range of 88 g/m² to 96 g/m², for example, in the range of 90 g/m² to 94 g/m². In addition, the thickness of the fourth wrapper 244 may be within a range of 120 μm to 130 μm, for example, about 125 μm.

The fifth wrapper 245 may be made of a sterilized paper MFW. Here, the sterilized paper MFW refers to a paper specially prepared such that the tensile strength, water resistance, and smoothness thereof are improved compared to ordinary paper. For example, the basis weight of the fifth wrapper 245 may be within 57 g/m² to 63 g/m², for example, about 60 g/m². In addition, the thickness of the fifth wrapper 245 may be within a range of 64 μm to 70 μm, for example, about 67 μm.

A certain material may be added into the fifth wrapper 245. Here, silicon may be used as an example of the certain material. However, embodiments of the present disclosure are not limited thereto. For example, silicon possesses characteristics such as thermal resistance resulting in little change with temperature, non-oxidizing nature, resistance to various chemicals, water repellency, and electrical insulation.

However, even if it is not silicon, any material having the above-described charac-teristics may be applied (or coated) to the fifth wrapper 245.

The fifth wrapper 245 may prevent combustion of the cigarette 2. For example, if the tobacco rod 210 is heated by the heater 13, the cigarette 2 may be combusted. In detail, when the temperature of any one of the materials included in the tobacco rod 310 rises above the ignition point, the cigarette 2 may be combusted. Even in this case, because the fifth wrapper 245 includes a non-combustible material, the cigarette 2 may be prevented from being combusted.

In addition, the fifth wrapper 245 may prevent the aerosol generating device 1 from being contaminated by materials generated in the cigarette 2. Liquid may be generated from the cigarette 2 by a user's puff. For example, because the aerosol generated from the cigarette 2 is cooled by air from the outside, liquid (for example, moisture, etc.) may be generated. Because the cigarette 2 is wrapped by the fifth wrapper 245, liquid generated from the cigarette 2 may be prevented from leaking outside the cigarette 2.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but is not limited thereto. Also, the tobacco rod 21 may include other additives, such as flavors, a wetting agent, and/or organic acid. Also, the tobacco rod 21 may include a flavored liquid, such as menthol or a moisturizer, which is sprayed onto the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat conductive material may be, but is not limited to, a metal foil such as aluminum foil. For example, the heat conductive material surrounding the tobacco rod 21 may uniformly distribute heat transmitted to the tobacco rod 21, and thus, the heat con-ductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may include a cellulose acetate filter. For example, the first segment may be a tube-shaped structure including a hollow inside. When the heater 13 is inserted by the first segment, the inner material of the tobacco rod 210 may be prevented from being pushed backward, and a cooling effect of the aerosol may be generated. A diameter of the hollow included in the first segment may be implemented within a range of about 2 mm to about 4.5 mm, but embodiments are not limited thereto.

A length of the first segment may be implemented within a range of about 4 mm to about 30 mm, but embodiments are not limited thereto. For example, the length of the first segment may be about 10 mm, but is not limited thereto.

The rigidity of the first segment may be controlled by controlling the content of the plasticizer during the manufacture of the first segment. In addition, the first segment may be manufactured by inserting a structure such as a film or tube made of the same material or different materials to the inside (i.e., the hollow) of the first segment.

The second segment of the filter rod 22 cools the aerosol generated by heating the tobacco rod 21 through the heater 13. Accordingly, the user may inhale the aerosol cooled to an appropriate temperature.

The length or diameter of the second segment may be determined in various ways according to the form of cigarette 2. For example, the length of the second segment can be implemented appropriately within a range of about 7 mm to about 20 mm. For example, the length of the second segment may be about 14 mm, but is not limited thereto.

The second segment may be made by weaving polymer fibers. In this case, flavoring liquid may be applied to fibers made of polymer. Alternatively, the second segment may be manufactured by weaving a separate fiber onto which flavoring liquid is applied and a fiber made of polymer together. Alternatively, the second segment may be formed by a crimped polymer sheet.

For example, polymer may be formed of a material selected from a group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by a polymer fiber or a crimped polymer sheet, the second segment may include a single or a plurality of channels extending in a lon-gitudinal direction. Here, the channel refers to a passage through which a gas (e.g., air or aerosol) passes.

For example, the second segment consisting of a crimped polymer sheet may be formed of a material having a thickness between about 5 μm and about 300 μm, for example, between about 10 μm, and about 250 μm. In addition, the entire surface area of the second segment may be between about 300 mm²/mm and about 1,000 mm²/mm. In addition, an aerosol cooling element may be formed of a material having a specific surface area of between about 10 mm²/mg and about 100 mm²/mg.

The second segment may include a thread containing volatile flavor components. Here, volatile flavor components may be menthol, but are not limited thereto. For example, in a thread, a sufficient amount of menthol may be filled so that menthol of more than 1.5 mg may be provided to the second segment.

The third segment of the filter rod 22 may include a cellulose acetate filter. The length of the third segment may be implemented appropriately within a range of about 4 mm to about 20 mm. For example, the length of the third segment may be about 12 mm, but is not limited thereto.

The third segment may be manufactured such that flavor is generated by spraying flavoring liquid on the third segment. Alternatively, a separate fiber to which a flavoring liquid is applied may be inserted into the third segment. The aerosol generated by the tobacco rod 21 is cooled as it passes through the second segment of the filter rod 22, and the cooled aerosol is delivered to the user through the third segment. Thus, when a flavoring element is added to the third segment, the persistence of the flavor transmitted to the user may be enhanced.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 5, the cigarette 3 may further include a front-end plug 33. The front-end plug 33 may be located on a side of the tobacco rod 31, the side facing the filter rod 32. The front-end plug 33 may prevent the tobacco rod 31 from escaping to the outside and may prevent a liquefied aerosol from flowing from the tobacco rod 31 into an aerosol generating device (1 of FIGS. 1 to 3) during smoking.

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and the total length of the cigarette 3 may correspond to the diameter and the total length of the cigarette 2 of FIG. 4. For example, the length of the front-end plug 33 may be about 7 mm, the length of the tobacco rod 31 may be about 15 mm, the length of the first segment 321 may be about 12 mm, and the length of the second segment 322 may be about 14 mm, but it is not limited to this.

The cigarette 3 may be wrapped by at least one wrapper 35. The wrapper 35 may have at least one hole through which external air may be introduced or internal air may be discharged. For example, the front-end plug 33 may be wrapped by a first wrapper 351, the tobacco rod 31 may be wrapped by a second wrapper 352, the first segment 321 may be wrapped by a third wrapper 353, and the second segment 322 may be wrapped by a fourth wrapper 354. Also, the entire cigarette 3 may be re-wrapped by a fifth wrapper 355.

Also, the fifth wrapper 355 may have at least one hole 36. For example, the hole 36 may be formed in an area surrounding the tobacco rod 31, but is not limited thereto. The hole 36 may serve to transfer heat generated by the heater 13 illustrated in FIGS. 2 and 3 to the inside of the tobacco rod 31.

Also, the second segment 322 may include at least one capsule 34. Here, the capsule 34 may generate a flavor or an aerosol. For example, the capsule 34 may have a configuration in which a liquid containing a flavoring material is wrapped with a film. The capsule 34 may have a spherical or cylindrical shape, but is not limited thereto.

The first wrapper 351 may be a combination of a general filter wrapper and a metal foil such as aluminum foil. For example, the overall thickness of the first wrapper 351 may be within a range of about 45 μm to about 55 μm, for example, about 50.3 μm. In addition, the thickness of a metal foil of the first wrapper 351 may be within a range of about 6 μm to about 7 μm, for example, about 6.3 μm. In addition, the basis weight of the first wrapper 351 may be within about 50 g/m² to about 55 g/m², for example, about 53 g/m².

The second wrapper 352 and the third wrapper 353 may be made of a general filter wrapper. For example, the second wrapper 352 and the third wrapper 353 may be a porous wrapper or a non-porous wrapper.

For example, the porosity of the second wrapper 352 may be 35,000 cu, but is not limited thereto. In addition, the thickness of the second wrapper 352 may be within a range of about 70 μm to about 80 μm, for example, about 78 μm. In addition, the basis weight of the second wrapper 352 may be within about 20 g/m² to about 25 g/m², for example, about 23.5 g/m².

For example, the porosity of the third wrapper 353 may be 24,000 cu, but is not limited thereto. In addition, the thickness of the third wrapper 353 may be within a range of about 60 μm to about 70 μm, for example, about 68 μm. In addition, the basis weight of the third wrapper 353 may be within about 20 g/m² to about 25 g/m², for example, about 21 g/m².

The fourth wrapper 354 may be made of a PLA laminating paper. Here, the PLA laminating paper refers to a three-layer paper including a paper layer, a PLA layer, and a paper layer. For example, the thickness of the fourth wrapper 354 may be within a range of about 100 μm to about 120 μm, for example, about 110 μm. In addition, the basis weight of the fourth wrapper 354 may be within a range of about 80 g/m² to about 100 g/m², for example, about 88 g/m².

The fifth wrapper 355 may be made of a sterilized paper MFW. Here, the sterilized paper MFW refers to a paper specially prepared such that the tensile strength, water resistance, and smoothness thereof are improved compared to ordinary paper. For example, the basis weight of the fifth wrapper 355 may be within about 57 g/m² to about 63 g/m², for example, about 60 g/m². In addition, the thickness of the fifth wrapper 355 may be within a range of about 64 μm to about 70 μm, for example, about 67 μm.

A certain material may be added into the fifth wrapper 355. Here, silicon may be used as an example of the certain material. However, embodiments are not limited thereto. For example, silicon has properties such as heat resistance resulting in little change with temperature, non-oxidizing nature, resistance to various chemicals, water repellency, electrical insulation, or the like. However, even if it is not silicon, any material having the above-described characteristics may be applied (or coated) to the fifth wrapper 355.

The front-end plug 33 may be made of cellulose acetate. As an example, the front-end plug 33 may be generated by adding a plasticizer (e.g., triacetin) to the cellulose acetate tow. The mono denier of a filament constituting the cellulose acetate tow may be within a range of about 1.0 to about 10.0, for example, from about 4.0 to about 6.0. For example, the mono denier of the filament of the front-end plug 33 may be 5.0. In addition, the cross section of the filament constituting the front-end plug 33 may be a Y-shaped type. The total denier of the front-end plug 33 may be within a range of about 20,000 to about 30,000, for example, from about 25.000 to about 30,000. For example, the total denier of the front-end plug 33 may be 28,000.

In addition, as needed, the front-end plug 33 may include at least one channel, and the cross-sectional shape of the channel may be manufactured in various ways.

The tobacco rod 31 may correspond to the tobacco rod 21 described above with reference to FIG. 4. Therefore, the specific description of the tobacco rod 31 is omitted below.

The first segment 321 may be made of cellulose acetate. For example, the first segment may be a tube-shaped structure including a hollow inside. The first segment 321 may be produced by adding a plasticizer (e.g., triacetin) to the cellulose acetate tow. For example, the mono denier and the total denier of the first segment 321 may be the same as the mono denier and the total denier of the front-end plug 33.

The second segment 322 may be made of cellulose acetate. The mono denier of the filament constituting the second segment 322 may be within a range of about 1.0 to about 10.0, for example, from about 8.0 to about 10.0. For example, the mono denier of the filament of the second segment 322 may be 9.0. In addition, the cross-section of the filament of the second segment 322 may be a Y-shaped type. The total denier of the second segment 322 may be within a range of about 20,000 to about 30,000, for example, about 25,000.

FIG. 6 is a perspective view of an aerosol generating device according to an embodiment.

Referring to FIG. 6, the aerosol generating device 10 according to an embodiment may include a main body 610, a heater module 620, and a cartridge 630.

The main body 610 is located under the heater module 620 and may support the heater module 620, and components for the operation of the aerosol generating device 10 may be arranged inside the main body 610. For example, a battery (not shown) and a controller (not shown) may be disposed inside the main body 610. However, the battery and the controller are only examples of components arranged inside the main body 610, and components other than the components described above (e.g., a user interface, a sensor, etc.) may further be arranged in the main body 610.

The heater module 620 may be located between the cartridge 630 and the main body 610, and may generate an aerosol by converting the phase of the aerosol generating material into gas. Aerosol generating materials supplied from the cartridge 630 may be heated to generate an aerosol.

For example, the heater module 620 may heat the aerosol generating material supplied from the cartridge 630 to generate vapor from the aerosol generating material, and the generated vapor may be mixed with external air introduced from the outside into the heater module 620 to generate an aerosol. Herein, the “aerosol” may refer to particles generated by mixing vapor generated by heating the aerosol generating material and air, and the expression may be used in the same sense below.

An aerosol generating material may be stored in the cartridge 630, and the aerosol generating material stored in the cartridge 630 may be supplied to the heater module 620 arranged at the lower end (e.g., an end in the −z direction of FIG. 6) of the cartridge 630.

In an embodiment, the cartridge 630 may include a mouthpiece 630m for supplying aerosol to the user. For example, the mouthpiece 630m may connect or provide fluid communication between the inside of the heater module 620 and the outside of the aerosol generating device 10, and the aerosol generated in the heater module 620 may be discharged to the outside of the aerosol generating device 10 through the mouthpiece 630m. That is, the user's mouth may be brought into contact with the mouthpiece 630m and the user may inhale the aerosol discharged to the outside of the aerosol generating device 10.

In an embodiment, the aerosol generating device 10 may further include a cover 611 that protects the components of the aerosol generating device 10.

The cover 611 may be arranged to surround at least partially the main body 610, the heater module 620, and the cartridge 630. As such, cover 611 may fix the position of the main body 610, the heater module 620, and the cartridge 630, and protect the main body 610, the heater module 620, and the cartridge 630 from external impact or the inflow of foreign matter.

In an embodiment, the cover 611 may be formed integrally with the main body 610, but embodiments are not limited thereto. In some embodiments, the cover 611 may be detachably coupled to the main body 610.

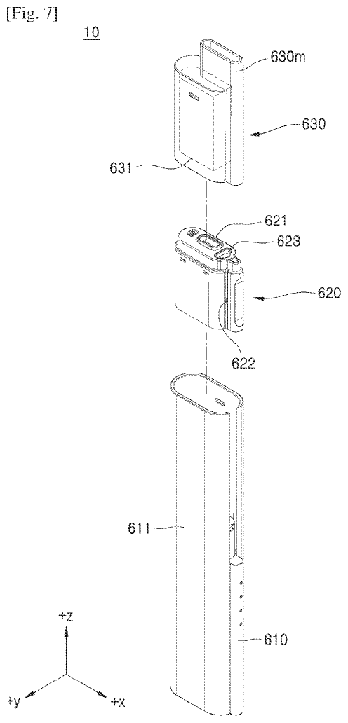

Hereinafter, with reference to FIG. 7, the coupling relationship of the main body 610, the heater module 620, and the cartridge 630 will be described in detail.

FIG. 7 is an exploded perspective view the aerosol generating device shown in FIG. 6.

Referring to FIG. 7, the aerosol generating device 10 according to an embodiment may include the main body 610, the cover 611, the heater module 620, and the cartridge 630. The components of the aerosol generating device 10 may be the same as or similar to at least one of components of the aerosol generating device 10 illustrated in FIG. 6, and descriptions of the same component as above will be omitted.

In addition, the components of the aerosol generating device 10 are not limited thereto, and at least one of the components described above (e.g. the cover 611) may be omitted or other components may be added.

The main body 610 may be detachably coupled to the bottom surface (e.g., a surface facing the −z direction of FIG. 7) of the heater module 620 to support the heater module 620. For example, the main body 610 may be inserted into or separated from an insertion groove (not shown) formed at the bottom surface of the heater module 620, but the coupling method of the heater module 620 and the main body 610 is not limited thereto.

In an embodiment, components to operate the aerosol generating device 10 may be arranged inside the main body 610. For example, a battery (not shown) to supply power and a controller (not shown) to control the operation of the aerosol generating device 10 may be arranged in the main body 610.

The battery may supply power used for the operation of the aerosol generating device 10. For example, the battery may be electrically connected to the heater module 620 to supply power to the heater module 620 and heat the heater of the heater module 620. Also, the battery may supply power necessary for the operation of other components (e.g., the controller) of the aerosol generating device 10.

The controller may control overall operations of the aerosol generating device 10. The controller may be implemented as an array of a plurality of logic gates or may be implemented as a combination of a general-purpose microprocessor and a memory in which a program executable in the microprocessor is stored, but embodiments are not limited thereto.

In an embodiment, the controller may control power supplied to the heater of the heater module 620 from the battery. For example, the controller may control the amount of power supplied from the battery to the heater and the time when power is supplied so that the heater of the heater module 620 may be heated to a predetermined temperature or maintained at a predetermined temperature.

The heater module 620 may be detachably coupled to the bottom surface (e.g., surface facing the −z direction of FIG. 7) of the cartridge 630, and may heat the aerosol generating material supplied from the reservoir 631 of the cartridge 630 to generate an aerosol.

For example, a first coupling member (not shown) arranged in one area of the heater module 620 facing the cartridge 630 may be coupled to and separated from a second coupling member (not shown) arranged on the bottom surface of the cartridge 630, and thus the heater module 620 may be detachably attached to the cartridge 630. However, the coupling method of the cartridge 630 and the heater module 620 is not limited thereto.

In an embodiment, the heater module 620 may include an aerosol generating material inlet 621 connecting the inside of the heater module 620 with the inside of the reservoir 631, an air inlet 622 through which external air is flown into the heater module 620, and an air outlet 623 through which an aerosol generated inside the heater module 620 is discharged to the outside.

The aerosol generating material stored in the reservoir 631 of the cartridge 630 may be flown into the heater module 620 through the aerosol generating material inlet 621, and the heater (not shown) arranged in the heater module 620 may heat the aerosol generating material supplied from the reservoir 631.

External air may flow into the heater module 620 through the air inlet 622, and vapor generated by heating external air flown into the heater module 620 and the aerosol generating material may be mixed to generate an aerosol.

The aerosol generated in the heater module 620 may be flown from the heater module 620 to the cartridge 630 through the air outlet 623 arranged in one area of the heater module 620 facing the cartridge 630, and then, may be discharged to the outside of the aerosol generating device 10 through the mouthpiece 630m. For example, as the pressure inside the cartridge 630 decreases by user's inhalation through the mouthpiece 630m, the air and/or aerosol inside the heater module 620 may move to the inside of the cartridge 630 of the heater module 620, thereby allowing the user to inhale air and/or aerosol present in the cartridge 630.

The cartridge 630 may include the reservoir 631 in which the aerosol generating material is stored and the mouthpiece 630m (e.g., the mouthpiece 630m of FIG. 6) for supplying the user with the aerosol generated in the heater module 620.

When the cartridge 630 and the heater module 620 are coupled, the reservoir 631 may be connected or in fluid communication with the inner space of the heater module 620, and accordingly, the aerosol generating material may be flown into the inner space of the heater module 620.

In this case, the aerosol generating material stored in the reservoir 631 may include a tobacco-containing material including a volatile tobacco flavor ingredient or a liquid composition including a nontobacco material.

In an embodiment, the liquid composition may include one component of water, solvents, ethanol, plant extracts, spice, flavoring, and vitamin mixtures, or a mixture of these components. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for forming the nicotine salts may be appropriately selected in consideration of a blood nicotine absorption rate, an operating temperature of the aerosol generating device 10, savor or flavor, solubility, and so on. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

In the aerosol generating device 10 according to an embodiment, the cartridge 630 and the heater module 620 may be individually replaced because the cartridge 630 is detachably coupled to the heater module 620, and the heater module 620 is detachably coupled to the main body 610.

For example, if the aerosol generating material stored in the reservoir 631 of the cartridge 630 is depleted, the user may continue smoking by replacing the existing cartridge 630 with a new cartridge 630, without replacing the heater module 620. As another example, if the performance of the components (e.g., the heater or wick) of the heater module 620 is decreased and thus a sufficient amount of aerosol is not generated, the user may replace the existing heater module 620 with a new heater module 620, without replacing the cartridge 630, so that a sufficient amount of aerosol is generated.

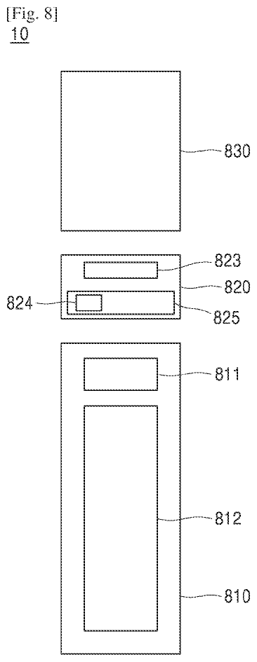

FIG. 8 is a block diagram illustrating a configuration of an aerosol generating device according to an embodiment.

Referring to FIG. 8, the aerosol generating device 1 may include a main body 810, a heater module 820, and a cartridge 830. Components relating to the present embodiment are illustrated in the aerosol generating device 10 of FIG. 8. Therefore, it will be understood by one of ordinary skill in the art related to the present embodiment that other general-purpose components may be further included in the aerosol generating device 10, in addition to the components illustrated in FIG. 8. For example, the aerosol generating device 10 may further include at least one of a sensor (not shown), a user interface (not shown), and a memory (not shown).

The sensor may include at least one of a puff sensor, a temperature sensor, and the like. A sensing result of the sensor may be transmitted to a controller 811 inside the main body 810, and the controller 811 may control the aerosol generating device 10 according to the sensing result to perform various functions such as controlling operation of a heater 823 inside the heater module 820, limiting smoking, determining whether or not a cartridge 830 or the heater module 820 is coupled, and displaying a notification.

The user interface may provide information on a state of the aerosol generating device 10 to a user. The user interface may include various types of interfacing elements such as a display or lamp outputting visual information, a motor outputting tactile information, a speaker outputting sound information, input/output (I/O) interfacing elements (e.g., a button and a touch screen) receiving information input from the user or outputting information to the user, terminals performing data communication or supplied with charging power, and a communication interfacing module performing wireless communication (e.g., WI-FI, WI-FI Direct, Bluetooth, Near-Field Communication (NFC), or the like) with an external device. However, the aerosol generating device 10 may selectively include only some of the various user interface examples illustrated above.

The memory is hardware that stores various types of data processed in the aerosol generating device 10, and the memory may store the data processed by the controller 811 and data to be processed. The memory may be implemented as various types, such as random access memory (RAM) such as dynamic random access memory (DRAM) and static random access memory (SRAM), read-only memory (ROM), and electrically erasable programmable read-only memory (EEPROM). The memory may store an operation time of the aerosol generating device 10, a greatest number of puffs, a current number of puffs, at least one temperature profile, and data on a user's smoking pattern.

The main body 810 may include the controller 811 and a battery 812, and the heater module 820 may include the heater 823, an integrated circuit 824, and a printed circuit board 825 on which the integrated circuit 824 is mounted. The heater module 820 may be detachably coupled to the main body 810, and the cartridge 830 may be detachably coupled to the heater module 820. Therefore, the heater module 820 and the cartridge 830 may be individually replaced, and thus, an exhaustion time of the aerosol generating material stored in the cartridge 830 and the durability of the heater module 820 may be individually considered in replacing components of the aerosol generating device 10.

The controller 811 is hardware that controls the overall operation of the aerosol generating device 10. The controller 811 may be implemented as an array of a plurality of logic gates or may be implemented as a combination of a general-purpose micro-processor and a memory in which a program executable in the microprocessor is stored. In addition, it will be understood by one of ordinary skill in the art that the controller 811 may be implemented in other forms of hardware.

The controller 811 analyzes the sensing result of the at least one sensor and controls subsequent processes. On the basis of the sensing result from the at least one sensor, the controller 811 may control power supplied to the heater 823 so that operation of the heater 823 starts or ends. For example, when a puff is detected by the puff sensor, the controller 811 may control the battery 812 to supply power to the heater 823.

The battery 812 may supply power to be used for the aerosol generating device 10 to operate. For example, the battery 812 may supply power so that the heater 823 may be heated. Also, the battery 812 may supply power for operations of other hardware components provided inside the aerosol generating device 10, e.g., the sensor, the user interface, the memory, and the controller 811. The battery 812 may be a rechargeable battery or a disposable battery. For example, the battery 812 may be a lithium polymer (LiPoly) battery, but is not limited thereto.

The heater 823 may refer to a device for heating an aerosol generating material. In an example, the heater 823 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. For example, the heater 823 may include at least one of a coil heater coupled to a silica wick, and a porous ceramic heater.

The integrated circuit 824 may refer to a control circuit mounted inside the heater module 820 separately from the controller 811 mounted on the main body 810. The integrated circuit 824 may be mounted on the printed circuit board 825 arranged in the heater module 820. The integrated circuit 824 may be implemented as an array of a plurality of logic gates or may be implemented as a combination of a general-purpose microprocessor and a memory in which a program executable in the microprocessor is stored.

When the heater module 820 is coupled to the main body 810, the integrated circuit 824 may be electrically connected to the controller 811. Then, the integrated circuit 824 may be used to perform authentication of the heater module 820 or prevent excessive use of the heater module 820.

The integrated circuit 824 may perform counting on the basis of a signal transmitted from the controller 8110 whenever an operation associated with the user's smoking (e.g., the user's puff) is detected by the controller 811 and store the number corresponding to a result of the counting. The number stored in the integrated circuit 824 is proportional to a time for which the heater module has performed the heating operation, and thus, a replacement time of the heater module may be accurately determined in consideration of the durability of the heater module by comparing the number stored in the integrated circuit 824 with a threshold value preset.

The integrated circuit 824 may include a counter for counting the number of puffs. Also, the integrated circuit 824 may include a nonvolatile memory for storing the counted number. The integrated circuit 824 includes a nonvolatile memory for storing the counted number, and thus, although a power supply to the integrated circuit 824 is cut off as the heater module is separated from the main body, the counted number may be continuously maintained. Therefore, even if the heater module 820 is separated from the main body 810 and recoupled to the same main body or another main body, its use beyond the durability of the heater module 820 may be prevented.

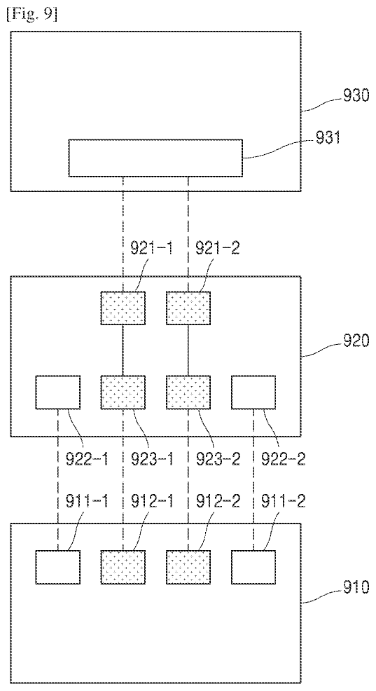

FIG. 9 illustrates a method of identifying a connection state of the cartridge and the heater module, according to an embodiment.

Referring to FIG. 9, the heater module 920 may include a first terminal 921-1 and 921-2, a second terminal 922-1 and 922-2, and a third terminal 923-1 and 923-2. The first terminal 921-1 and 921-2, the second terminal 922-1 and 922-2, and the third terminal 923-1 and 923-2 may each be configured in a pair.

When a cartridge 930 is coupled to the heater module 920, the first terminal 921-1 and 921-2 may electrically connect the cartridge 930 with the heater module 920. In detail, when the cartridge 930 is coupled to the heater module 920, the first terminal 921-1 and 921-2 may be electrically connected with the conductor 931 arranged in the cartridge 930 to configure a closed circuit.

When the heater module 920 is coupled to the main body 910, the second terminal 922-1 and 922-2 and the third terminal 923-1 and 923-2 of the heater module 920 may electrically connect the heater module 920 and the main body 910. Specifically, the second terminal 922-1 and 922-2 may be electrically connected to the first terminal 911-1 and 911-2 arranged in the main body 910, and the third terminal 923-1 and 923-2 may be electrically connected to the second terminal 912-1 and 912-2 arranged in the main body 910.

The main body 910 may include the first terminal 911-1 and 911-2 and the second terminal 912-1 and 912-2. The first terminal 911-1 and 911-2 and the second terminal 912-1 and 912-2 may each be configured in a pair. The first terminal 911-1 and 911-2 and the second terminal 912-1 and 912-2 may be electrically connected to the controller 811 arranged in the main body 910.

The first terminal 921-1 and 921-2 and the third terminal 923-1 and 923-2 arranged in the heater module 920 may be electrically connected to each other through the printed circuit board 825 arranged in the heater module 920. The integrated circuit 824 mounted on the printed circuit board 825 may be electrically connected to the controller 811 arranged in the main body 910 by being electrically connected to the third terminal 923-1 and 923-2.

When the cartridge 930 is coupled to the heater module 920, the conductor 931 arranged in the cartridge 930 may be electrically connected to the first terminal 921-1 and 921-2 of the heater module 920 and may generate a conducting signal. The conductor 931 may consist of an electrically conductive material. When the heater module 920 onto which the cartridge 930 is coupled is coupled to the main body 910, the controller may receive the conducting signal through the third terminal 923-1 and 923-2 of the heater module 920. The conducting signal is a signal applied through the third terminals 923-1 and 923-2 and the first terminals 921-1 and 921-2, and is an electrical signal mediated through the conductor 931. The conducting signal may be supplied from the battery under the control of the controller. In detail, the controller 811 may receive the conducting signal through the second terminal 912-1 and 912-2 of the main body 910 connected to the third terminal 923-1 and 923-2 of the heater module 920.

The controller 811 may identify whether the cartridge 930, the heater module 920, and the main body 910 are coupled to one another based on the strength of the conducting signal.

FIG. 10 is a flowchart of a method of determining whether a cartridge is coupled according to an embodiment.

In operation S1010, the controller 811 measures the conducting signal. The conducting signal may be generated by an electrical connection between the conductor 931 of the cartridge 930 and the first terminal 921-2 and 921-2 of the heater module 820 and 920. The conducting signal may be a current flow during a predetermined time or more or a current amount equal to or greater than a reference value. In an example, when the conducting signal is a current flow during a predetermined time or more, the current flow during a predetermined time or more may be determined to be a conducting signal, and a current flow lasting less than the predetermined time (including 0) may be determined to be a noise signal. In another example, when the conducting signal is a current amount greater than or equal to a reference value, the current amount greater than or equal to a reference value may be determined to be a conducting signal, and a current amount less than the reference value (including 0) may be determined to be a noise signal. The conducting signal and the noise signal may be distinguished by a plurality of criteria, including the above-described examples.

In operation S1020, the controller 811 may compare the conducting signal with a predetermined reference value. For example, the controller may determine whether the duration and/or the level of the conducting signal is below a certain threshold.

In operation S1030, when the conducting signal is greater than or equal to the reference value, the controller 811 may recognize that the cartridge 930 is in a coupled state. In detail, the controller 811 may recognize that the cartridge 830 and 930, the heater module 820 and 920, and the main body 810 and 910 are in a coupled state in the aerosol generating device 10.

In operation S1040, when the conducting signal is less than the reference value, the controller 811 may recognize that the cartridge 830 and 930 is not in a coupled state. In detail, the controller 811 may recognize that the cartridge 830 and 930, the heater module 820 and 920, or the main body 810 and 910 is not in a coupled state in the aerosol generating device 10.

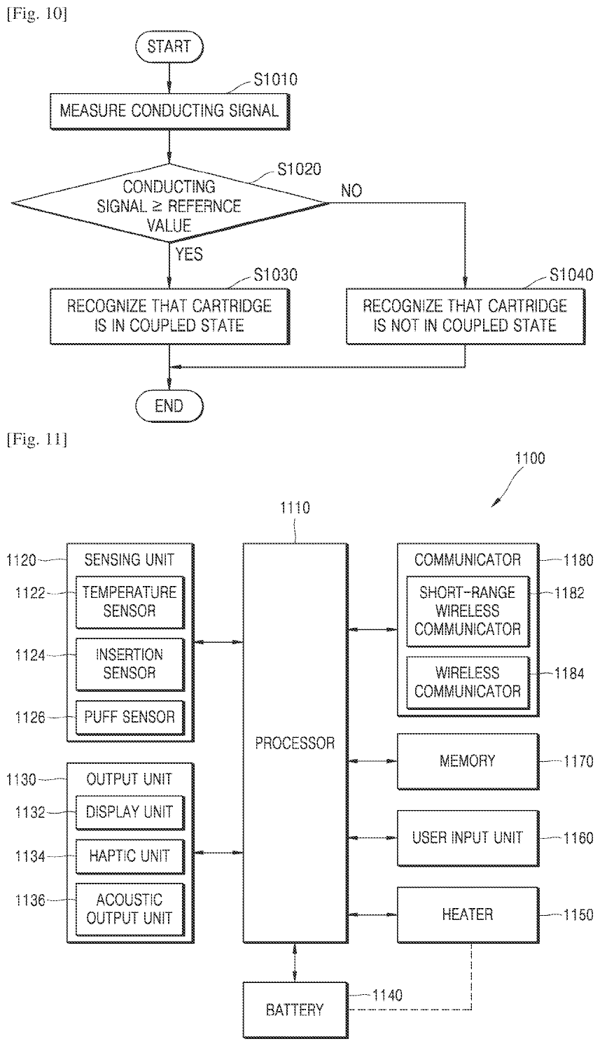

FIG. 11 is a block diagram of an aerosol generating device 1100 according to another embodiment.

The aerosol generating device 1100 may include a processor 1110, a sensing unit 1120, an output unit 1130, a battery 1140, a heater 1150, a user input unit 1160, a memory 1170, and a communicator 1180. However, the internal structure of the aerosol generating device 1100 is not limited to the structures illustrated in FIG. 11. In other words, according to the design of the aerosol generating device 1100, it will be understood by one of ordinary skill in the art that some of the components shown in FIG. 11 may be omitted or new components may be added.

The sensing unit 1120 may sense a state of the aerosol generating device 1100 and a state around the aerosol generating device 1100, and transmit sensed information to the processor 1110. Based on the sensed information, the processor 1110 may control the aerosol generating device 1100 to perform various functions, such as controlling an operation of the heater 1150, limiting smoking, determining whether an aerosol generating article (e.g., a cigarette, a cartridge, or the like) is inserted, displaying a notification, or the like.

The sensing unit 1120 may include at least one of a temperature sensor 1122, an insertion sensor 1124, and a puff sensor 1126, but is not limited thereto.

The temperature sensor 1122 may sense a temperature at which the heater 1150 (or an aerosol generating material) is heated. The aerosol generating device 1100 may include a separate temperature sensor for sensing the temperature of the heater 1150, or the heater 1150 may serve as a temperature sensor. Alternatively, the temperature sensor 1122 may also be arranged around the battery 1140 to monitor the temperature of the battery 1140.

The insertion sensor 1124 may sense insertion and/or removal of an aerosol generating article. For example, the insertion sensor 1124 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1126 may sense a user's puff on the basis of various physical changes in an airflow passage or an airflow channel. For example, the puff sensor 1126 may sense a user's puff on the basis of any one of a temperature change, a flow change, a voltage change, and a pressure change.

In addition to the sensors described above (including the temperature sensor 1122, the insertion sensor 1124, and the puff sensor 1126), the sensing unit 1120 may further include at least one of a temperature/humidity sensor, an atmospheric pressure sensor, a geomagnetic sensor, an acceleration sensor, a gyroscope sensor, a position sensor (e.g., GPS), a proximity sensor, and an RGB sensor (an illuminance sensor). Because the function of each sensor may be intuitively inferred from the name by one of ordinary skill in the art, the specific explanation may be omitted.

The output unit 1130 may output and provide information about the state of the aerosol generating device 1100 to the user. The output unit 1130 may include at least one of a display unit 1132, a haptic unit 1134, and an acoustic output unit 1136, but is not limited thereto. When the display unit 1132 and the touchpad form a layer structure and thereby form a touch screen, the display unit 1132 may be used as an input device in addition to an output device.

The display unit 1132 may visually provide information about the aerosol generating device 1100 to the user. For example, information about the aerosol generating device 1100 may mean various pieces of information, such as a charging/discharging state of the battery 1140 of the aerosol generating device 1100, a preheating state of the heater 1150, an insertion/removal state of an aerosol generating article, or a state in which the use of the aerosol generating device 1100 is restricted (e.g., sensing of an abnormal object), or the like, and the display unit 1132 may output the information to the outside. The display unit 1132 may include, for example, a liquid crystal display panel (LCD), an organic light-emitting display panel (OLED), etc. In addition, the display unit 1132 may be in the form of an LED light-emitting element.

The haptic unit 1134 may convert electrical signals to a mechanical or electrical stimuli to provide information about the aerosol generating device 1100 tactilely to the user. For example, the haptic unit 1134 may include a motor, a piezoelectric element, or an electrical stimulation device.

The acoustic output unit 1136 may audibly provide information about the aerosol generating device 1100 to the user. For example, the acoustic output unit 1136 may convert the electrical signal to an acoustic signal and output the converted signal to the outside.

The battery 1140 may supply power used to operate the aerosol generating device 1100. The battery 1140 may supply power such that the heater 1150 may be heated. In addition, the battery 1140 may supply power required for operations of other components (e.g., the sensing unit 1120, the output unit 1130, the user input unit 1160, the memory 1170, and the communicator 1180) in the aerosol generating device 1100. The battery 1140 may be a rechargeable battery or a disposable battery. For example, the battery 1140 may be a lithium polymer (LiPoly) battery, but is not limited thereto.

The heater 1150 may receive power from the battery 1140 to heat an aerosol generating material. Although not illustrated in FIG. 11, the aerosol generating device 1100 may further include a power conversion circuit (e.g., a direct current (DC)/DC converter) that converts and supplies power of the battery 1140 to the heater 1150. In addition, when the aerosol generating device 1100 generates aerosol in an induction heating method, the aerosol generating device 1100 may further include a DC/AC converter that converts a DC power source of the battery 1140 to an AC power source.

The processor 1110, the sensing unit 1120, the output unit 1130, the user input unit 1160, the memory 1170, and the communicator 1180 may each receive power from the battery 1140 to perform a function. Although not shown in FIG. 11, a power conversion circuit that converts the power of the battery 1140 and supplies the converted power to each component, for example, a low dropout (LDO) circuit or a voltage regulator circuit, may further be included.

In an embodiment, the heater 1150 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 130 may be implemented as a metal wire, a metal plate on which an electrically conductive track is arranged, a ceramic heating element, or the like, but is not limited thereto.

In some embodiments, the heater 1150 may be a heater of an induction heating type. For example, the heater 1150 may include a suspector that heats the aerosol generating material by generating heat through a magnetic field applied by a coil.

The user input unit 1160 may receive information input from the user or output the information to the user. For example, the user input unit 1160 may include a key pad, a dome switch, a touchpad (a touch-sensitive, capacitive method, a pressure resistance method, an infrared sensing method, a surface ultrasonic wave conduction method, an integrated tension measurement method, a piezo effect method, etc.), a jog wheel, a jog switch, etc., but is not limited thereto. In addition, although not shown in FIG. 11, the aerosol generating device 1100 may further include a connection interface such as a universal serial bus (USB) interface, and may be connected to other external devices through the connection interface such as the USB interface to thereby transmit and receive information or charge the battery 1140.

The memory 1170 is a hardware component that stores various types of data processed in the aerosol generating device 1100, and may store data processed and data to be processed by the processor 1110. The memory 1170 may include at least one type of storage medium among a flash memory type, a hard disk type, a multimedia card micro type, a card type memory (e.g., SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 1170 may store an operation time of the aerosol generating device 1100, the maximum number of puffs, the current number of puffs, at least one temperature profile, data on a user's smoking pattern, etc.

The communicator 1180 may include at least one component for communication with other electronic devices. For example, the communicator 1180 may include a short-range wireless communicator 1182 and a wireless communicator 1184.

The short-range wireless communicator 1182 may include a Bluetooth communicator, a Bluetooth low energy (BLE) communicator, a near field communicator, a WLAN communicator, a Zigbee communicator, an infrared data association (IrDA) communicator, a Wi-Fi direct (WFD) communicator, an ultra wideband (UWB) communicator, and Ant+ communicator, etc., but is not limited thereto.

The wireless communicator 1184 may include, but is not limited to, a cellular network communicator, an internet communicator, a computer network (e.g., LAN or WAN) communicator, etc. The wireless communicator 1184 may check and verify the aerosol generating device 1100 within a communication network using subscriber information (e.g., international mobile subscriber identifier (IMSI)).

The processor 1110 may control general operations of the aerosol generating device 1100. In an embodiment, the processor 1110 may include at least one processor. A processor may be implemented as an array of a plurality of logic gates or may be implemented as a combination of a general-purpose microprocessor and a memory in which a program executable in the microprocessor is stored. It will be understood by one of ordinary skill in the art that the processor can be implemented in other forms of hardware.

The processor 1110 may control the temperature of the heater 1150 by controlling power supply of the battery 1140 to the heater 1150. For example, the processor 1110 may control the power supply by controlling switching of a switching element between the battery 1140 and the heater 1150. In another example, a direct heating circuit may also control the power supply to the heater 1150 according to a control command of the processor 1110.

The processor 1110 may analyze the results detected by the sensing unit 1120 and control the processes to be performed. For example, the processor 1110 may control power supplied to the heater 1150 to start or end an operation of the heater 1150 on the basis of a result sensed by the sensing unit 1120. In another example, the processor 1110 may control, based on a result sensed by the sensing unit 1120, an amount of power supplied to the heater 1150 and the time during which power is supplied, such that the heater 1150 may be heated to a certain temperature or maintained at an appropriate temperature.

The processor 1110 may control the output unit 1130 based on a result sensed by the sensing unit 1120. For example, when the number of puffs counted through the puff sensor 1126 reaches a preset number, the processor 1110 may notify the user that the aerosol generating device 1100 will soon be terminated through at least one of the display unit 1132, the haptic unit 1134, and the acoustic output unit 1136.

The processor 1110 may output a control signal based on a user input through the user input unit 1160, but may output different control signals in response to the same user input according to whether the cartridge is coupled.

In detail, the processor 1110 may recognize that the cartridge is not in a coupled state when the received conducting signal is less than the reference value (e.g., the duration and/or the level of the conducting signal is below a certain threshold), and may output a first control signal in response to the user input that is input through the user input unit 1160. On the other hand, the processor 1110 may recognize that the cartridge is in a coupled state when the received conducting signal is greater than or equal to the reference value, and may output a second control signal in response to the user input that is input through the user input unit 1160.

For example, in response to the same input of the user, the processor 1110 may output the first control signal to supply power to the heater 1150 when the processor 1110 recognizes that the cartridge is in a coupled state, but may output the second control signal to block the power supplied to the heater 1150 when the processor 1110 recognizes that the cartridge is not in a coupled state.

In another example, in response to the same input of the user, the processor 1110 may output the first control signal to supply a first power to the heater 1150 when the processor 1110 recognizes that the cartridge is in a coupled state, but may output the second control signal to supply a second power to the heater 1150 when the processor 1110 recognizes that the cartridge is not in a coupled state. Here, the second power may be greater than the first power. The first power may be power supplied to the heater 1150 in a general smoking mode, and the second power may be power supplied to the heater 1150 in a cleaning mode wherein the heater is heated with a higher temperature than a general smoking mode to vaporize residue of the aerosol generating material. Therefore, the aerosol generating device 1100 according to an embodiment may implement two operations in response to one user input according to whether the cartridge is in a coupled state, without needing to be provided separately with the user input unit 1160 to heat the heater 1150 in the smoking mode and the user input unit 1160 to operate in the cleaning mode. That is, since the aerosol generating device 1100 according to an embodiment operates differently in response to the same user input according to whether the cartridge is coupled, the user input interface may be simplified.

In an embodiment, the processor 1110 may recognize that the cartridge is not in a coupled state when the received conducting signal is less than a reference value, and may display a first user interface (UI) screen through the display unit 1132. On the other hand, the processor 1110 may recognize that the cartridge is in a coupled state when the received conducting signal is greater than or equal to the reference value, and may output a second UI screen different from the first UI. For example, icons related to the cleaning mode may be arranged in the first UI, and icons related to the smoking mode may be arranged in the second UI.

One embodiment may also be implemented in the form of a computer-readable recording medium including instructions executable by a computer, such as a program module executable by the computer. The computer-readable recording medium may be any available medium that can be accessed by a computer and includes both volatile and nonvolatile media, and removable and non-removable media. In addition, the computer-readable recording medium may include both a computer storage medium and a communication medium. The computer storage medium includes all of volatile and nonvolatile, and removable and non-removable media implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a main body comprising a controller and a battery;
a heater module detachably coupled to the main body and comprising a heater configured to heat an aerosol generating material; and
a cartridge detachably coupled to the heater module and configured to store the aerosol generating material to be delivered to the heater,
wherein
the heater module comprises:
a first terminal configured to electrically connect the cartridge to the heater module when the cartridge is coupled to the heater module, and
a second terminal and a third terminal configured to electrically connect the heater module to the controller when the heater module is coupled to the main body.

2. The aerosol generating device of claim 1, wherein the heater module further comprises a printed circuit board electrically connecting the first terminal to the third terminal.

3. The aerosol generating device of claim 2, wherein
the heater module further comprises an integrated circuit mounted on the printed circuit board, and
the integrated circuit is electrically connected to the controller through the third terminal.

4. The aerosol generating device of claim 3, wherein the integrated circuit is configured to count a number of puffs based on a signal transmitted from the controller whenever a puff is detected, and store the counted number.

5. The aerosol generating device of claim 4, wherein the integrated circuit comprises a non-volatile memory storing the number.

6. The aerosol generating device of claim 1, wherein the heater receives power from the battery through the second terminal.

7. The aerosol generating device of claim 1, wherein the cartridge further comprises an conductor that is electrically connected to the first terminal when the cartridge is coupled to the heater module.

8. The aerosol generating device of claim 7, wherein
the conductor generates an conducting signal when the conductor is electrically connected to the first terminal, and
the controller receives the conducting signal through the third terminal.

9. The aerosol generating device of claim 8, wherein the conducting signal is a current flow during a predetermined time or more or a current amount equal to or greater than a reference value.

10. The aerosol generating device of claim 8, wherein
the aerosol generating device further comprises a user input unit configured to receive a user input, and
the controller is further configured to, in response to the user input, output a first control signal when the conducting signal is less than a reference value, and
output a second control signal different from the first signal when the conducting signal is greater than or equal to the reference value.

11. The aerosol generating device of claim 10, wherein the first control signal is a signal that blocks power supplied to the heater.

12. The aerosol generating device of claim 1, wherein the first terminal, the second terminal, and the third terminal are each configured in a pair.
